(19) United States
(12) Patent Application Publication
(10) Pub. No.: US 2025/0253548 A1
(43) Pub. Date: Aug. 7, 2025

(54) ELECTRONIC DEVICES AND ANTENNAS

(71) Applicant: Apple Inc., Cupertino, CA (US)

(72) Inventors: Patrick J. Crowley, Santa Clara, CA (US); Collin J. Richardson, El Dorado Hills, CA (US); Nicholas S. Brodine, Los Gatos, CA (US); Eric T. Chiang, San Francisco, CA (US); Mario Martinis, Cupertino, CA (US); Zhe Wang, Cupertino, CA (US)

(21) Appl. No.: 18/435,940

(22) Filed: Feb. 7, 2024

(51) Int. Cl. H01Q 21/28; H01Q 1/27

(52) U.S. Cl. CPC H01Q 21/28; H01Q 1/273

(57) ABSTRACT

Electronic devices including antennas disposed outside a device housing are disclosed. In an example, an electronic device includes a device housing defining an internal volume, a radio disposed in the internal volume, an antenna disposed outside the internal volume and coupled to the radio through the device housing, and a conductive element coupled to a ground of the radio. The conductive element can extend from the internal volume through the device housing to an exterior of the device housing. The conductive element can define at least a portion of an exterior surface of the electronic device.

### FIELD

The described embodiments relate generally to electronic devices, such as wearable electronic devices. More particularly, the present embodiments relate to wearable electronic devices that include antennas with increased lengths, which allow the wearable electronic devices to radiate to a broader range of frequencies.

### BACKGROUND

Electronic devices are increasingly being designed with device portability in mind, for example, to allow users to use these devices in a wide variety of situations and environments. In the context of wearable devices, these devices can be designed to include many different functionalities and to be operated in many different locations and environments. The components of an electronic device, for example, the processors, memory, antennas, display, and other components can partially determine a level of performance of the electronic device. Further, the arrangement of these components with respect to one another in the device can also determine the level of overall performance of the electronic device.

Continued advances in electronic devices and their components have enabled considerable increases in performance. Existing components and structures for electronic devices can, however, limit the levels of performance of such devices. For example, while some components can achieve high levels of performance in some situations, the inclusion of multiple components in devices sized to enhance portability can limit the performance of the components, and thus, the performance of the device. Consequently, further tailoring and arrangement of components for electronic devices to provide additional or enhanced functionality, can be desirable.

### SUMMARY

In at least one example of the present disclosure, an electronic device includes a device housing defining an internal volume, a radio disposed in the internal volume, an antenna disposed outside the internal volume and coupled to the radio through the device housing, and a conductive element coupled to a ground of the radio. The conductive element can extend from the internal volume through the device housing to an exterior of the device housing. The conductive element can define at least a portion of an exterior surface of the electronic device.

In some examples, the electronic device further includes a securement strap coupled to the device housing. The antenna can be embedded in the securement strap. The securement strap can include a conductive contact coupling the antenna to the radio. In some examples, the conductive contact includes a first conductive contact. The securement strap can be received in a slot in the device housing. The slot can include a second conductive contact coupling the first conductive contact to the radio.

In some examples, the electronic device further includes a first securement strap and a second securement strap. The antenna can be a first antenna disposed in the first securement strap. The second securement strap can include a second antenna disposed therein. The second antenna can be coupled to the first antenna.

In some examples, the conductive element extends around a circumference of the device housing.

In at least one example of the present disclosure, a securement strap for an electronic device includes a band, an antenna in the band, and a contact in the band and coupled to the antenna. The contact can be configured to couple the antenna to an electronic device. An effective radiating length of the antenna can be adjustable to improve radiation of a signal through the antenna to a specific frequency.

In some examples, the band has a first configuration and a second configuration. The first configuration can include a folded compact configuration. The second configuration can include an unfolded deployed configuration. In some examples, the band can include a securement feature configured to retain the band in the compact configuration. The securement feature can include at least one of a stitch, a magnet, a wrap at least partially encircling the band, or a hook-and-loop fastener.

In some examples, the band can include an extension feature extending parallel to the antenna. The band can be configured to separate along the extension feature to adjust the effective radiating length of the antenna. In some examples, the band can include an extension feature extending perpendicular to the antenna. The band can be configured to separate along the extension feature to adjust the effective radiating length of the antenna. In some examples, the antenna has a rectangular serpentine shape. The band can include a plurality of extension features. The band can be configured to separate along the extension features to adjust the effective radiating length of the antenna.

In some examples, the contact can include a spring pin. In some examples, the contact can include an inductive contact. In some examples, the band has a length of at least 40 cm. In some examples, the antenna can include at least one of an S-shaped serpentine pattern or a conductive grid.

In at least one example of the present disclosure, an electronic device includes a device housing, a radio in the device housing, an antenna connector coupled to the radio, and a conductive element coupled to the radio. The antenna can be configured to couple an antenna to the radio through the device housing. The conductive element can define an exterior surface of the device housing.

In some examples, the electronic device further includes an antenna receptacle coupled to the antenna connector. The antenna receptacle can include a retractable antenna coupled to the radio through the antenna connector. In some examples, the antenna connector can include a conductive contact or an inductive coil coupled to the radio.

In some examples, the electronic device can further include a first slot in the device housing, a second slot in the device housing, a securement strap, and an antenna coupled to the antenna connector. The antenna connector can be disposed in the first slot. The securement strap can include a first securement feature received in the first slot and a second securement feature received in the second slot. An effective length of the antenna can be configured to be increased by removing the second securement feature from the second slot.

In some examples, the electronic device further includes a slot in the device housing and a securement strap. The antenna connector can be disposed in the slot. The securement strap can include an antenna coupled to the antenna connector and a securement feature received in the slot. Lengths of the securement strap and the antenna can be adjustable by unfolding the securement strap.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows a perspective view of a wearable electronic device.

FIG. 1B shows a top perspective view of a portion of the wearable electronic device of FIG. 1A.

FIG. 1C shows a bottom perspective view of a portion of the wearable electronic device of FIG. 1A.

FIG. 2A shows a perspective view of a wearable electronic device.

FIG. 2B shows a perspective view of the wearable electronic device of FIG. 2A.

FIG. 2C shows an exploded view of the wearable electronic device of FIG. 2A.

FIG. 2D shows a front view of a portion of the wearable electronic device of FIG. 2A.

FIG. 2E shows a bottom perspective view of a portion of the wearable electronic device of FIG. 2A.

FIG. 3 shows a front view of a user operating a wearable electronic device.

FIGS. 4A through 4C show front views of straps for a wearable electronic device.

FIG. 5A shows a side view of a wearable electronic device in a folded configuration.

FIG. 5B shows a side view of the wearable electronic device of FIG. 5A in an extended configuration.

FIGS. 6A and 6B show front views of straps for a wearable electronic device.

FIG. 7A shows a side view of a wearable electronic device in a wrapped configuration.

FIG. 7B shows a side view of the wearable electronic device of FIG. 7A in an extended configuration.

FIG. 8 shows a side view of a wearable electronic device.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure generally relates to electronic devices. More particularly, the present disclosure relates to wearable electronic devices and portable electronic devices. The wearable electronic devices of the present disclosure include tailored arrangements of components to provide additional or enhanced functionality, without introducing or increasing undesirable device properties or performance. In this way, more functionality and componentry can be included in wearable devices for users to wear and operate in any condition or activity without limiting the functionality and durability of the devices.

In some examples, the wearable electronic devices can include components that can be used to broadcast signals with an increased range. For example, a wearable electronic device can include an antenna with an increased length, which allows the wearable electronic device to radiate to lower frequencies. Radio waves with lower frequencies can travel greater distances relative to waves with higher frequencies. Thus radiating to lower frequencies enables the wearable electronic device to broadcast with a greater range. As an example, this can be used to send emergency signals long distances from remote locations.

The wearable electronic device can include a housing in which a radio receiver and/or a radio transmitter are disposed (collectively referred to as a radio or a radio transceiver). The wearable electronic device can further include an antenna that is disposed outside the housing. The antenna can be connected to the radio through the housing. In some examples, the antenna can be included in a strap or band of the wearable electronic device. In some examples, the antenna can have an adjustable length (e.g., an adjustable effective radiating length), which can be used to tune a frequency to which the radio radiates through the antenna. For example, the antenna can be folded, coiled, telescoped, or the like to adjust an effective radiating length of the antenna, which can be used to optimize radiation through the antenna to selected frequencies. By providing the antenna outside the housing of the wearable electronic device, an antenna with an increased length can be provided, and the wearable electronic device can broadcast to lower frequencies and with greater range.

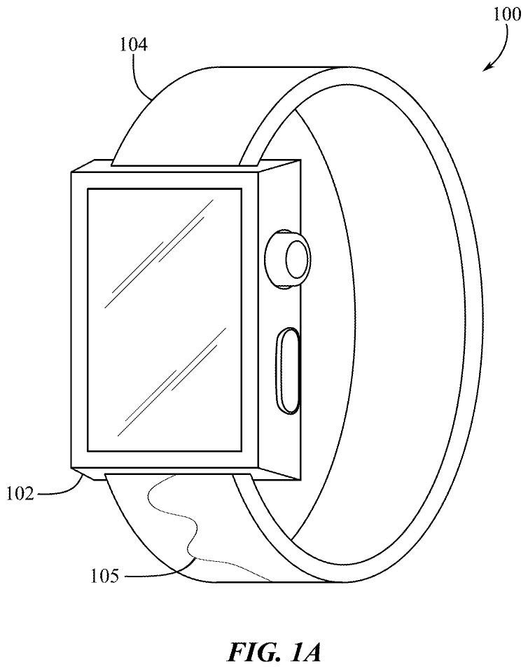

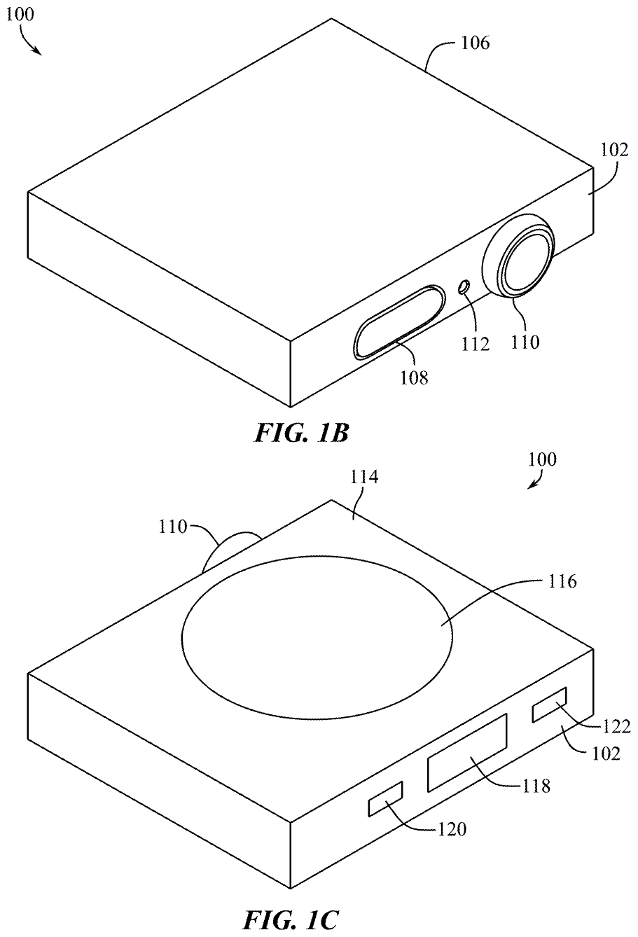

These and other embodiments are discussed below with reference to FIGS. 1A through 8. However, those skilled in the art will readily appreciate that the detailed description given herein with respect to these Figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIGS. 1A through 1C illustrate perspective views of an electronic device 100. As illustrated in FIGS. 1A through 1C, the electronic device 100 can be a watch, such as a smartwatch. However, the electronic device 100 illustrated in FIGS. 1A through 1C is merely one representative example of a device that can be used in conjunction with the systems and methods disclosed herein. The electronic device 100 can correspond to any form of wearable or portable electronic device, such as a portable media player, a media storage device, a portable digital assistant (“PDA”), a tablet computer, a computer, a mobile communication device, a GPS unit, a remote control device, a transceiver (e.g., an avalanche transceiver), or another electronic device. The electronic device 100 can be referred to as an electronic device, a consumer device, or the like. In some examples, the electronic device 100 can include a housing 102 that can carry operational components, for example, in an internal volume at least partially defined by the housing 102. The electronic device 100 can also include a strap 104, or other retaining component that can secure the electronic device 100 to a body of a user as desired.

An antenna 105 can be included in the strap 104, outside of the housing 102. The antenna 105 can be embedded in or otherwise disposed in the strap 104. The antenna 105 can be coupled to a radio of the electronic device 100 through the housing 102. The antenna 105 can be formed from a conductive material, such as a metal including silver, copper, gold, platinum, palladium, aluminum, alloys or combinations thereof, or the like. The antenna 105 can have an increased length relative to an antenna included within the housing 102. Due to the increased length of the antenna 105, the electronic device 100 can radiate to lower frequencies at increased distances. In some examples, this can be used to send signals (e.g., emergency signals) from the electronic device 100 radiating through the antenna 105, even when the electronic device 100 does not have access to network services (e.g., cellular networks, Wi-Fi networks, and the like), such as when the electronic device 100 is in a remote location.

As will be discussed in detail herein, the antenna 105 can be provided in a folded, retracted, wrapped, or other compact configuration, and can be deployed in an extended configuration. This allows for an antenna 105 with an increased length to be provided in a small package. The antenna 105 can have an adjustable length (e.g., an adjustable effective radiating length). For example, the antenna 105 can have a folded, compact configuration and an unfolded, deployed, or extended configuration. An effective radiating length of the antenna 105 can be adjusted by transitioning the antenna 105 between the compact configuration and the deployed configuration to optimize radiation through the antenna 105 to selected frequencies, such that the electronic device 100 can broadcast or radiate to desired frequencies. In some examples, the antenna 105 can be partially extended or deployed to adjust the effective radiating length of the antenna 105 to optimize radiation to intermediate frequencies. This can be used to broadcast signals through the antenna 105 to specific frequencies with reduced power requirements, over increased distances, and the like.

Various types of antennas can be used for the antenna 105. In some examples, the antenna 105 can be a monopole antenna. A conductive element can be included in the housing 102 of the electronic device 100. The conductive element can be isolated from the antenna 105 and coupled to the radio of the electronic device 100. The conductive element can be exposed through the housing 102, pass through the housing 102, and be coupled to the radio of the electronic device 100 inside the housing 102. In other words, the conductive element can extend through the housing 102 and can define at least a portion of an exterior surface of the electronic device 100. A user of the electronic device 100 can touch the conductive element to their skin or another conductive object in order to provide a ground for the radio of the electronic device 100. In some examples, the antenna 105 can be a dipole antenna. The electronic device 100 can include two straps 104, which each include an antenna 105. Both antennas 105 can be coupled to the radio through the housing 102. One of the antennas 105 can be used to broadcast a signal from the radio, and the other of the antennas 105 can be used to ground the radio. In some examples, the antenna 105 can be a loop antenna. The antenna 105 can be coupled to the radio through opposite sides of the housing 102 in order to form a loop.

In examples in which the electronic device 100 includes a monopole antenna 105 or dipole antennas 105, a user of the electronic device 100 may hold the electronic device 100 by the housing 102 or one of the straps 104, respectively, with the antennas 105 extended in order to optimally broadcast a signal. In an example in which the electronic device 100 includes a loop antenna 105, a user of the electronic device 100 may optimally broadcast a signal with the electronic device 100 positioned on their wrist. Configurations using the monopole antenna 105 or the dipole antennas 105 may have increased range and be able to broadcast to lower frequencies; configurations using the loop antenna 105 may be used with minimal user input.

The antenna 105 of the electronic device 100 can be used to broadcast to low frequencies, such as frequencies in a range of about 80 MHz to about 500 MHz, in a range of about 120 MHz to about 450 MHZ, in a range of about 100 MHz to about 250 MHz, in a range of about 100 MHz to about 175 MHz, about 100 MHz, about 120 MHZ, about 150 MHz, about 160 MHz, about 240 MHz, about 400 MHZ, about 410 MHz, or other similar low frequencies. The antenna 105 can be used to broadcast to a VHF frequency (in a range from about 30 MHz to about 300 MHz, or about 156.80 MHZ), an APRS frequency (about 144.390 MHZ), a VHF emergency frequency (about 146.520 MHZ), an international air distress frequency (in a range from about 110 MHz to about 250 MHz, about 121.50 MHz, or about 243.00 MHZ), a satellite search and rescue frequency (about 146.520 MHZ), a NWR SAME frequency (about 164 MHZ), or the like.

The antenna 105 of the electronic device 100 can have a length of about 40 cm, about 50 cm, about 60 cm, about 70 cm, about 75 cm, about 80 cm, about 90 cm, about 100 cm, in a range from about 40 cm to about 110 cm, in a range from about 65 cm to about 85 cm, or the like. The length of the antenna 105 can be related to the frequency that the antenna 105 of the electronic device 100 is configured to broadcast to. For example, the length of the antenna 105 can be based on a wavelength, a half wavelength, or a quarter wavelength of a frequency to which the antenna 105 of the electronic device 100 is configured to broadcast. In an example in which the electronic device 100 is configured to broadcast to a frequency of about 100 MHZ having a wavelength of about 1.5 m, the antenna 105 can have a length of about 75 cm (e.g., the length of the antenna 105 is half the wavelength of the frequency to which the antenna 105 is configured to broadcast). Providing the electronic device 100 with the antenna 105 having a length configured to broadcast to a specific frequency can improve the efficiency of the electronic device 100 broadcasting to the selected frequency.

Although the conductive element has been described as providing a ground and the antenna 105 has been described as being used for radiating or broadcasting a signal, in some embodiments, the antenna 105 can be used to provide the ground and the conductive element can be used to broadcast or radiate a signal. For example, a user can contact the conductive element to part of their body or another conductive object, and the signal can be radiated through the conductive element and the conductive object in contact with the conductive element.

In FIGS. 1B and 1C, the strap 104 has been omitted. As illustrated in FIG. 1B, the electronic device 100 can include a housing 102 and a display assembly 106 attached to the housing 102. The housing 102 and the display assembly 106 can each define at least a portion of an exterior surface of the electronic device 100.

The display assembly 106 can include a glass, a plastic, or any other substantially transparent exterior layer, material, component, or assembly. The display assembly 106 can include multiple layers, with each layer providing a unique function, as described herein. The display assembly 106 can be, or can be a part of, an interface component of the electronic device 100. The display assembly 106 can define a front exterior surface of the electronic device 100. The surface defined by the display assembly 106 can be considered an interface surface. In some examples, the interface surface defined by display assembly 106 can receive inputs, such as touch inputs, from a user.

In some examples, the housing 102 can be a substantially continuous or unitary component and can define one or more openings to receive components of the electronic device 100. In some examples, the electronic device 100 can include input components such as one or more buttons 108 and/or a crown 110 that can be disposed in the openings defined in the housing 102. In some examples, a material can be disposed between the buttons 108 and/or crown 110 and the housing 102 to provide an airtight and/or watertight seal at the locations of the openings. The housing 102 can also define one or more openings or apertures, such as aperture 112 that can allow for sound to pass into or out of the internal volume defined by the housing 102. For example, the aperture 112 can be in communication with a microphone component disposed in the internal volume. In some examples, the housing 102 can define or include a feature, such as an indentation to removably couple the housing 102 and a strap or retaining component (e.g., the strap 104 of FIG. 1A).

FIG. 1C illustrates a bottom perspective view of the electronic device 100. The electronic device 100 can include a back cover 114 that can be attached to the housing 102, for example, opposite the display assembly 106. The back cover 114 can include ceramic, plastic, metal, or combinations thereof. In some examples, the back cover 114 can include an at least partially electromagnetically transparent component 116. The electromagnetically transparent component 116 can be transparent to any desired wavelengths of electromagnetic radiation, such as visible light, infrared light, radio waves, or combinations thereof. In some examples, the electromagnetically transparent component 116 can allow sensors and/or emitters disposed in the housing 102 to communicate with the external environment. Together, the housing 102, the display assembly 106 and the back cover 114 can define an internal volume and an external surface of the electronic device 100.

The housing 102 can further define one or more openings to receive components of the electronic device 100 in a sidewall opposite a sidewall in which the button 108 and the crown 110 are disposed. For example, as illustrated in FIG. 1C, the electronic device 100 can include a button 118, a first speaker vent 120, and a second speaker vent 122. The button 118 can be disposed between the first speaker vent 120 and the second speaker vent 122. The first speaker vent 120 and the second speaker vent 122 can provide fluid communication from a common speaker volume behind one or more speakers and the sidewall of the housing 102 (e.g., within an internal volume defined by the housing 102) to the external environment. The button 118 can be disposed between the first speaker vent 120 and the second speaker vent 122 to save space and provide a compact design without interrupting the functionality of the one or more speakers communicating with the external environment through the first speaker vent 120 and the second speaker vent 122.

Any of the features, components, and/or parts, including the arrangements and configurations thereof shown in FIGS. 1A through 1C can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 1A through 1C.

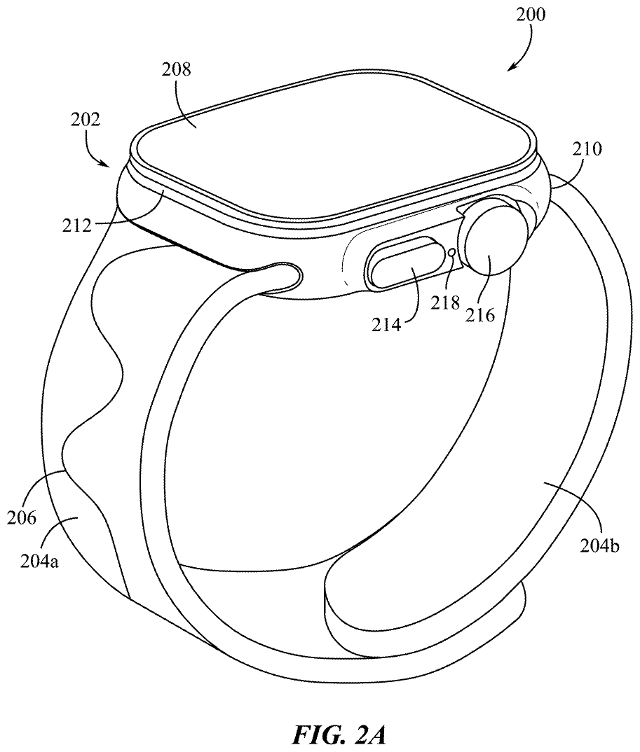

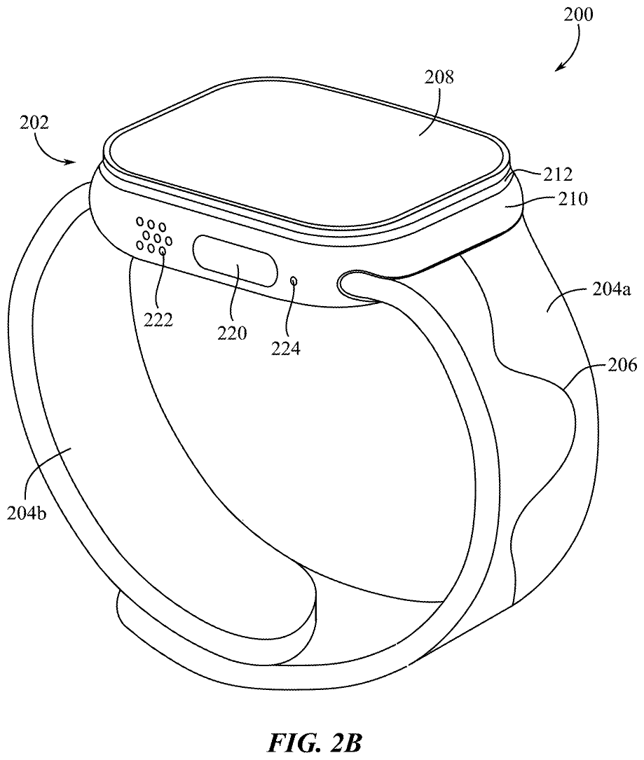

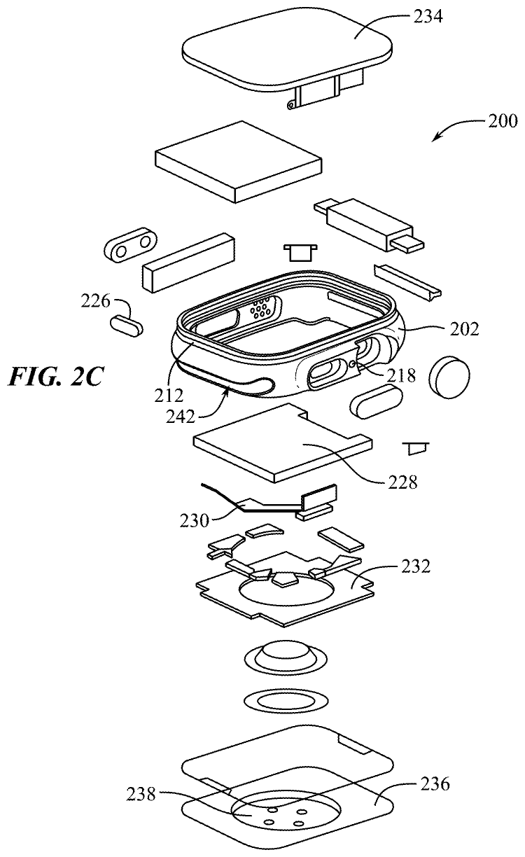

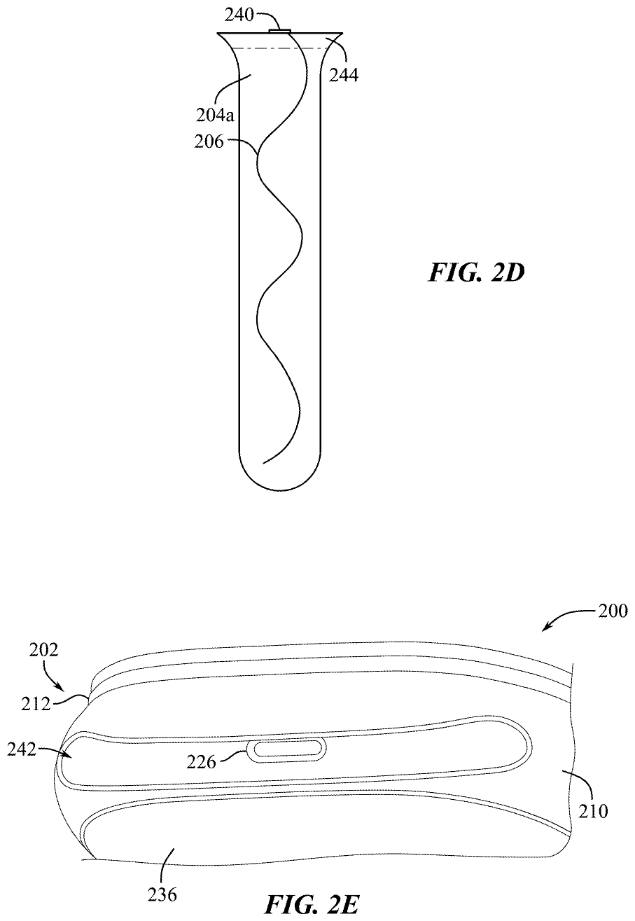

FIGS. 2A and 2B illustrate perspective views of an electronic device 200 (also referred to as a wearable electronic device or a portable electronic device). FIG. 2C illustrates an exploded view of the electronic device 200. FIG. 2D illustrates a front view of a securement strap 204a of the electronic device 200. FIG. 2E illustrates a bottom perspective view of a portion of the electronic device 200. The electronic device 200 includes a housing 202 with sidewalls 210. The housing 202 includes slots defined in opposite ones of the sidewalls 210 which can be used to removably couple securement straps 204a, 204b to the housing 202. The securement strap 204a can include an antenna 206, which can be coupled to components of the electronic device 200 through the housing 202. The securement strap 204b can also include an antenna 206. The antennas 206 can be embedded in or otherwise disposed in each of the securement straps 204a, 204b. The housing 202 defines an opening in which a conductive element 212 is disposed and an opening in which a display cover 208 is disposed.

The antennas 206 can be provided in the securement strap 204a and/or the securement strap 204b outside the housing 202 to provide the electronic device 200 with antennas 206 having increased lengths. In conventional electronic devices, antennas may be disposed within a housing, and the dimensions of the housing can limit the length of the antennas. Providing the antennas 206 in the securement straps 204a, 204b outside the housing 202 with increased lengths allows for the electronic device 200 to broadcast signals to lower frequencies, at increased distances, and with improved efficiency. This can be used to broadcast signals from the electronic device 200 even in cases in which the electronic device 200 does not have access to network services, such as cellular networks, Wi-Fi networks, and the like (e.g., when the electronic device 200 is located in a remote location). In some examples, the antennas 206 can have adjustable lengths (e.g., adjustable effective radiating lengths), which can be used to optimize broadcasting to specific frequencies.

The antennas 206 can be formed from conductive materials, such as metals. For example, the antennas 206 can include silver, copper, gold, platinum, palladium, aluminum, alloys or combinations thereof, or the like. The antennas 206 can include conductive elastomers. In some examples, the antennas 206 can include conductive fibers that can be woven in a fabric material of the securement straps 204. The antennas 206 can include conductive particles that can be insert molded into a material of the securement straps 204. As illustrated in FIG. 2A, the antenna 206 can have a curved S-shape (e.g., a serpentine shape), however, other shapes are possible. For example, the antenna 206 can be shaped as a grid (e.g., a conductive grid), a rectangular S-shape (e.g., a rectangular serpentine shape), a line or rectangle, or any other suitable shape.

In some examples, the antenna 206 of the securement strap 204a can be coupled to the antenna 206 of the securement strap 204b, which can extend a length and an effective radiating length of the antenna 206, or allow the antenna 206 to operate as a loop antenna. As an example, the antenna 206 of the securement strap 204a can be coupled to the antenna 206 of the securement strap 204b, the securement strap 204b can be detached from the housing 202, and the electronic device 200 can broadcast through both of the antennas 206 to double the length of each of the respective antennas 206 (e.g., doubling an effective radiating length of the respective antennas 206). In some examples, the securement straps 204 can include insulating materials and/or the antennas 206 can be coated in insulating materials. This can prevent any inadvertent electrical contacts between a user of the electronic device 200 and the antennas 206 while the antennas 206 are in use.

The antenna 206 of the electronic device 200 can be used to broadcast to low frequencies, such as frequencies in a range of about 80 MHz to about 500 MHz, in a range of about 120 MHz to about 450 MHz, in a range of about 100 MHz to about 250 MHz, in a range of about 100 MHz to about 175 MHz, about 100 MHZ, about 120 MHz, about 150 MHz, about 160 MHz, about 240 MHz, about 400 MHZ, about 410 MHz, or other similar low frequencies. The antenna 105 can be used to broadcast to a VHF frequency (in a range from about 30 MHz to about 300 MHz, or about 156.80 MHZ), an APRS frequency (about 144.390 MHZ), a VHF emergency frequency (about 146.520 MHZ), an international air distress frequency (in a range from about 110 MHz to about 250 MHz, about 121.50 MHz, or about 243.00 MHZ), a satellite search and rescue frequency (about 146.520 MHZ), a NWR SAME frequency (about 164 MHZ), or the like.

The conductive element 212 can be provided in the housing 202 to supply a ground for the radio of the electronic device 200. As illustrated in FIGS. 2A and 2B, the conductive element 212 can extend around at least a portion of a circumference of the housing 202. The conductive element 212 can encircle or surround the display cover 208. The conductive element 212 can define at least a portion of an exterior surface of the housing 202 of the electronic device 200. The conductive element 212 can be isolated from the antennas 206. The conductive element 212 can be coupled to the radio of the electronic device 200 through the housing 202. In other words, the conductive element 212 can extend through the housing 202 to be coupled to the radio of the electronic device 200. The conductive element 212 can be exposed through the housing 202 such that a user of the electronic device 200 can contact the conductive element 212 to their skin or another conductive object. The conductive element 212 can be formed from a conductive material, such as a metal. For example, the conductive element 212 can include silver, copper, gold, platinum, palladium, aluminum, alloys or combinations thereof, or the like.

The antennas 206 and/or the conductive element 212 can be coupled to a radio of the electronic device 200. In an example in which one antenna 206 is provided in one of the securement straps 204a, 204b, the antenna 206 can be used to broadcast a signal, and the conductive element 212 can be used as a ground. Thus, the antenna 206 can operate as a monopole antenna. In an example in which two antennas 206 are provided with one antenna 206 being provided in each of the securement straps 204a, 204b, one of the antennas 206 can be used to broadcast a signal, and the other antenna 206 or the conductive element 212 can be used as a ground. Thus, the antennas 206 can operate as a dipole antenna or a monopole antenna, respectively. In some examples, in which two antennas 206 are provided with one antenna 206 being provided in each of the securement straps 204a, 204b, the antennas 206 can be coupled to one another and function as a single antenna to broadcast a signal. Thus, the antennas 206 can operate as a loop antenna.

Although the conductive element 212 has been described as providing a ground and the antennas 206 have been described as being used for radiating or broadcasting a signal, in some embodiments, the antennas 206 can be used to provide the ground and the conductive element 212 can be used to broadcast or radiate a signal. For example, a user can contact the conductive element 212 to part of their body or another conductive object, and the signal can be radiated through the conductive element 212 and the conductive object in contact with the conductive element.

The sidewalls 210 of the housing 202 can define an opening in which the display cover 208 is disposed. In at least one example, the sidewalls 210 of the housing 202 can define an upper peripheral edge of the electronic device 200 surrounding the display cover 208. In at least one example, the display cover 208 defines a top surface of the electronic device 200 disposed in a plane. The top surface can include an outward facing surface of the display cover 208. In at least one example, the display cover 208 can be a transparent display cover disposed above or over other display layers. In at least one example, the outward facing surface of the display cover 208 can be planar.

In at least one example, as shown in FIG. 2A, the sidewalls 210 can define a first side of the electronic device 200 defining recessed features in which a crown 216 and a button 214 are positioned. The crown 216 can be a part of a turn dial button or other functional knob configured to be manipulated by the user. The crown 216 can be disposed in the recessed portion, as noted above. In at least one example, the protrusion can include a window exposing a circumferential side surface of the crown 216 where a user can manually manipulate the crown 216 within the recess. The button 214 shown in FIG. 2A can also be at least partially surrounded by an outwardly extending portion of the sidewall 210, such that the button 214 is disposed within another recess thereof. The housing 202 can also define one or more openings or apertures, such as an aperture 218 that can allow for sound to pass into or out of an internal volume defined by the sidewalls 210. For example, the aperture 218 can be in communication with a microphone component disposed in the internal volume. The aperture 218 can be disposed between the crown 216 and the button 214.

In at least one example, as shown in FIG. 2B, the sidewalls 210 can define a second side opposite the first side shown in FIG. 2A. In such an example, the electronic device 200 can include a first speaker vent 222, a second speaker vent 224, and a button 220 disposed within an aperture defined by the sidewalls 210 between the first speaker vent 222 and the second speaker vent 224. The first and second speaker vents 222, 224 can provide fluid communication from a common speaker volume behind the sidewall 210 (e.g., within an internal volume defined by the sidewalls 210) and the external environment. The button 220 can be disposed between the first and second speaker vents 222, 224 to save space and provide a compact design without interrupting the functionality of the one or more speakers communicating with the external environment through the first and second speaker vents 222, 224.

FIG. 2C illustrates an exploded view of the electronic device 200. The electronic device 200 includes a display assembly 234, the housing 202, and a back cover 236. An electromagnetically transparent component 238 can be defined in the back cover 236. The exploded view of FIG. 2C illustrates various internal components that may be disposed within an internal volume defined by the housing 202, the back cover 236, and the display assembly 234. For example, the electronic device 200 can include one or more printed circuit boards (PCBs) 228, one or more antenna components 232, electrical connectors and flexes 230, a radio, microphones, buttons, seals, gaskets, memory components, processors, sensors, dials, batteries, and so forth.

The antennas 206 and the conductive element 212 can be coupled to the radio through the electrical connectors and flexes 230. For example, the conductive element 212 can extend through the housing 202 and can be coupled to the radio through the electrical connectors and flexes 230. The securement straps 204a, 204b can be removably coupled to the housing 202 through slots 242 defined in the sidewalls 210 between the display assembly 234 and the back cover 236. The securement straps 204a, 204b can include conductive contacts coupled to the antennas 206. Conductive contacts 226 can be disposed in the slots 242 and can be coupled to the radio through the electrical connectors and flexes 230. Thus, the antennas 206 can be coupled to the radio through the conductive contacts of the securement straps 204a, 204b, the conductive contacts 226 of the slots 242, and the electrical connectors and flexes 230. The conductive contacts 226 can be used to connect the antennas 206 to the radio, and can be referred to as antenna connectors or the like. The conductive contacts of the securement straps 204a, 204b and/or the conductive contacts 226 of the slots 242 can include spring pins to ensure good contact is made between the conductive contacts of the securement straps 204a, 204b and the conductive contacts 226.

The slots 242 can be configured to retain the securement straps 204a, 204b. For example, the slots 242 can mechanically retain the securement straps 204a, 204b. The slots 242 can removably retain the securement straps 204a, 204b. The securement straps 204a, 204b can be slidably inserted into and removed from the slots 242. The slots 242 and the securement straps 204a, 204b can be shaped to guide the securement straps 204a, 204b into the slots 242 in a desired orientation. The slots 242 can release the securement straps 204a, 204b in response to a button push or the like. The slots 242 and the securement straps 204a, 204b can include various detent features, such as protrusions and recesses, which can be activated/deactivated using the button or the like. The slots 242 and the securement straps 204a, 204b can include magnets, which can be used to guide the securement straps 204a, 204b into the slots 242, aid in aligning the securement straps 204a, 204b in the slots 242, and/or retain the securement straps 204a, 204b in the slots 242.

The conductive contacts 226 can be formed from conductive materials, such as metals or the like. For example, the conductive contacts 226 can include silver, copper, gold, platinum, palladium, aluminum, alloys or combinations thereof, or the like. The conductive contacts 226 can be plated, coated, or covered by additional materials in order to prevent corrosion of the conductive contacts 226. In some examples, protective covers can be included over the conductive contacts 226, and the protective covers can be removed prior to broadcasting a signal through the conductive contacts 226 to the antennas 206. In some examples, the conductive contacts 226 can be replaced by inductive contacts (e.g., by inductive coils). In such examples, inductive contacts can be provided in the slots 242 and the securements straps 204a, 204b. The antennas 206 can be coupled to the inductive contacts of the securements straps 204a, 204b and the inductive contacts in the slots 242 can be coupled to the radio through the electrical connectors and flexes 230. The antennas 206 can be operated by induction through the inductive contacts in the slots 242 and the inductive contacts of the securement straps 204a, 204b. Providing inductive contacts can improve waterproofing and reduce corrosion in the electronic device 200.

In some examples, the conductive contacts 226 (also referred to as antenna connectors) can be disposed outside of the slots 242. For example, a port can be provided anywhere in the housing 202, and a conductive contact 226 can be disposed in the port. An external antenna can be positioned in the port and connected to the radio of the electronic device 200 through the conductive contact 226 disposed in the port. Thus, the external antenna can be connected to the radio through the housing 202 by way of the conductive contact 226 in the port, and outside of the slot 242. In some examples, an antenna connector can include an inductive contact positioned adjacent to or in a sidewall or back surface of the housing 202. An external antenna with an inductive contact can be positioned adjacent to the inductive contact and can be connected to the radio of the electronic device 200 through the inductive contact disposed. Thus, the external antenna can be connected to the radio through the housing 202 by way of the inductive contact disposed in or adjacent to the sidewall or back surface of the housing 202 and outside of the slot 242. Magnets can be included in housing 202 and/or the external antenna in order to assist with aligning the inductive contact of the external antenna with the inductive contact of the electronic device 200.

FIG. 2D illustrates a securement strap 204a of the electronic device 200. The securement strap 204a includes an antenna 206, a conductive contact 240, and a securement feature 244. The conductive contact 240 can be coupled to the antenna 206, and can be used to couple the antenna 206 to a conductive contact 226 disposed in a slot 242 of the electronic device 200. The conductive contact 240 can be formed from conductive materials, such as metals or the like. For example, the conductive contact 240 can include silver, copper, gold, platinum, palladium, aluminum, alloys or combinations thereof, or the like. The conductive contact 240 can be plated, coated, or covered by additional materials in order to prevent corrosion of the conductive contact 240. In some examples, a protective cover can be included over the conductive contact 240, and the protective cover can be removed prior to broadcasting a signal through the conductive contact 240 to the antenna 206. The conductive contact 240 can include a spring pin to ensure good contact is made between the conductive contact 240 of the securement strap 204a and the conductive contact 226 of the electronic device 200. The conductive contact 240 can be replaced by an inductive contact in examples in which the electronic device 200 includes an inductive contact disposed in the slot 242.

The securement feature 244 can be configured to engage with the slot 242 in order to retain the securement strap 204a in the slot 242. The securement feature 244 can be slidably inserted into and removed from the slots 242. The securement feature 244 can include detent features, magnets, and the like, that interface with features of the slots 242 to guide the securement feature 244 into a respective slot 242 and retain the securement feature 244 in the slot 242.

FIG. 2E illustrates a conductive contact 226 disposed in a slot 242 of the electronic device 200. The slot 242 in the housing 202 of the wearable electronic device 200 and the securement feature 244 of the securement straps 204 can be configured to secure the securement strap 204 in the slot 242 at a range of angles. The conductive contact 226 and the conductive contact 240 can be oriented in the slot 242 and on the securement strap 204 such that contact is maintained between the conductive contact 226 and the conductive contact 240 throughout the range of angles that the securement strap 204 can move relative to the slot 242.

Any of the features, components, and/or parts, including the arrangements and configurations thereof shown in FIGS. 2A through 2E can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 2A through 2E.

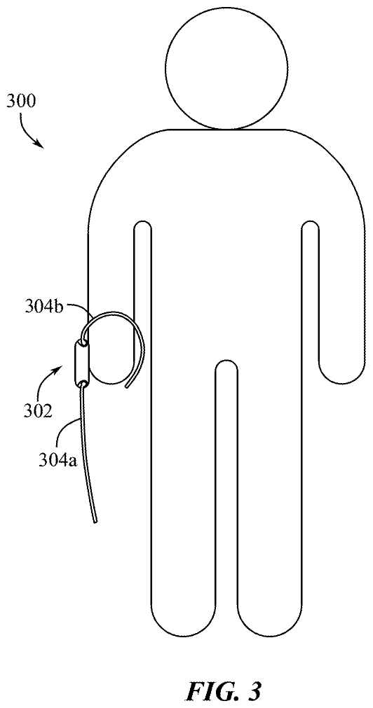

FIG. 3 illustrates a user 300 operating an electronic device 302. The electronic device 302 can be the same as or similar to the electronic devices 100, 200, discussed above with respect to FIGS. 1A through 2E. The electronic device 302 can include two securement straps 304a and 304b, which can be used to secure the electronic device 302 to the body of the user 300. An antenna can be included in the securement strap 304a and/or the securement strap 304b. For example, an antenna can be embedded in or otherwise disposed in one or both of the securement straps 304a, 304b. A conductive element can be included in a housing of the electronic device 302. In the example of FIG. 3, an antenna is included in the securement strap 304a. The user 300 can operate the electronic device 302 by holding the electronic device 302 such that the securement strap 304a hangs from the electronic device 302 perpendicular to the ground (e.g., parallel to a direction of a gravitational force), with the user 300 contacting the conductive element of the housing of the electronic device 302 with their skin. The antenna in the securement strap 304a can have a relatively long length, and can be used to broadcast to low frequencies, over great distances, with improved efficiency. The body of the user 300 can be used as a ground for the antenna through the contact between the user's skin and the conductive element of the housing of the electronic device 302. Thus, in the example of FIG. 3, the antenna can operate as a monopole antenna.

In some examples, both the securement strap 304b and the securement strap 304a can include an antenna, and the electronic device 302 can operate with a dipole antenna. The user 300 can hold the securement strap 304b such that the housing of the electronic device 302 and the securement strap 304a hang from the hand of the user 300. One of the antennas in one of the securement straps 304a, 304b can be used to broadcast a signal, and the other antenna in the other of the securement straps 304a, 304b can be used as a ground. Thus, in an example similar to FIG. 3, the antennas can operate as a dipole antenna.

In some examples, both the securement strap 304b and the securement strap 304a can include an antenna, which can be coupled to one another, and the electronic device 302 can operate with a loop antenna. The electronic device 302 can be secured to an appendage of the user 300 with the securement straps 304a, 304b being coupled to one another. The antennas in both of the securement straps 304a, 304b can be used to broadcast a signal. Thus, in an example similar to FIG. 3, the antennas can operate as a loop antenna.

Although the user 300 is illustrated as contacting the conductive element of the electronic device 302 with their hand, the user 300 can contact the conductive element to another part of their body or another conductive object, such as a metal pole or the like. Although the conductive element has been described as providing a ground and the antenna has been described as being used for radiating or broadcasting a signal, in some embodiments, the antenna can be used to provide the ground and the conductive element can be used to broadcast or radiate a signal. For example, the user 300 can contact the conductive element to part of their body or another conductive object, and the signal can be radiated through the conductive element and the conductive object in contact with the conductive element.

The antenna(s) of the electronic device 302 can be used to broadcast to low frequencies, such as frequencies in a range of about 80 MHz to about 500 MHz, in a range of about 120 MHz to about 450 MHZ, in a range of about 100 MHz to about 250 MHz, in a range of about 100 MHz to about 175 MHz, about 100 MHz, about 120 MHz, about 150 MHz, about 160 MHz, about 240 MHz, about 400 MHZ, about 410 MHz, or other similar low frequencies. The antenna(s) can be used to broadcast to a VHF frequency (in a range from about 30 MHz to about 300 MHz, or about 156.80 MHZ), an APRS frequency (about 144.390 MHZ), a VHF emergency frequency (about 146.520 MHZ), an international air distress frequency (in a range from about 110 MHz to about 250 MHz, about 121.50 MHz, or about 243.00 MHZ), a satellite search and rescue frequency (about 146.520 MHZ), a NWR SAME frequency (about 164 MHZ), or the like.

The antenna(s) of the electronic device 302 can have lengths of about 40 cm, about 50 cm, about 60 cm, about 70 cm, about 75 cm, about 80 cm, about 90 cm, about 100 cm, in a range from about 40 cm to about 110 cm, in a range from about 65 cm to about 85 cm, or the like. The lengths of the antennas can be related to the frequency that the antennas of the electronic device 302 are configured to broadcast to. For example, the lengths of the antennas can be based on a wavelength, a half wavelength, or a quarter wavelength of a frequency to which the antennas of the electronic device 302 are configured to broadcast. In an example in which the electronic device 302 is configured to broadcast to a frequency of about 100 MHz having a wavelength of about 1.5 m, the antennas can have lengths of about 75 cm (e.g., the lengths of the antennas are half the wavelength of the frequency to which the antennas are configured to broadcast). Providing the electronic device 302 with antennas having lengths configured to broadcast to specific frequencies can improve the efficiency of the electronic device 302 broadcasting to the selected frequencies.

Any of the features, components, and/or parts, including the arrangements and configurations thereof shown in FIG. 3 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 3.

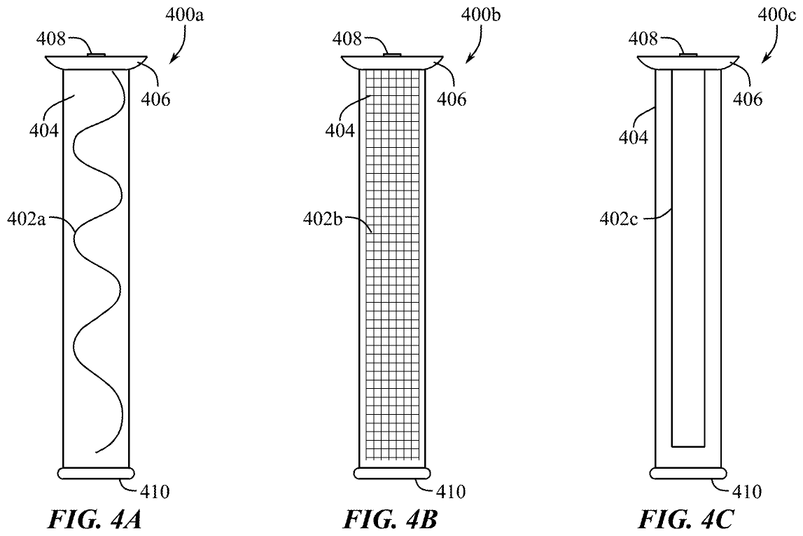

FIGS. 4A through 4C illustrate various configurations of antennas 402a-402c in securement straps 400a-400c. The securement straps 400a-400c can be used in electronic devices, such as the electronic devices 100, 200, 302, discussed above with respect to FIGS. 1A through 3. The features of the securement straps 400a-400c can be the same as or similar to features of the straps 104 and securement straps 204a, 204b, 304a, 304b discussed above with respect to FIGS. 1A through 3. As illustrated in FIGS. 4A through 4C, each of the securement straps 400a-400c can include an antenna 402a-402c, a band portion 404, a securement feature 406, a conductive contact 408, and an end portion 410. Each of the antennas 402a-402c can be embedded in or otherwise disposed in the respective securement straps 400a-400c.

In the example of FIG. 4A, the antenna 402a has a curved S-shape (e.g., a serpentine shape). The antenna 402a can have a rectangular S-shape or the like. Providing the antenna 402a with an S-shape can increase the length of the antenna 402a, without increasing the length of the securement strap 400a. In the example of FIG. 4B, the antenna 402b has grid shape (e.g., the antenna 402b includes a conductive grid) that is made up of parallel and perpendicular conductive portions. In the example of FIG. 4C, the antenna 402c has rectangular shape, which can be referred to as a foil shape or the like. Providing the antenna 402b, 402c with a grid-shape or a rectangular shape can increase a width of the antenna 402b, 402c, which can improve performance of the antenna 402b, 402c. The antennas 402a-402c can have any suitable shapes. In the examples of FIGS. 4A through 4C, the antennas 402a-402c can extend through a majority of a length and width of each respective securement strap 400a-400c. Providing the antennas 402a-402c with increased lengths can allow the antennas to broadcast to lower frequencies with increased efficiency and range. Providing the antennas 402a-402c with increased widths or thicknesses can improve the performance of the antennas 402a-402c, including the efficiency of the antennas 402a-402c.

The band portion 404 can include textiles (e.g., including materials such as polyester, nylon, spandex, silicone, combinations thereof, or the like), rubbers (e.g., elastomers), silicone, metals (e.g., stainless steel, titanium, or the like), or any other suitable materials. The band portion 404 can be formed from insulating materials to insulate the antennas 402a-402c from users and from a housing of an electronic device to which a respective securement strap 400a-400c is secured. In some examples, the band portion 404 can be formed from conductive materials, and the antennas 402a-402c can include insulating coatings to insulate the antennas 402a-402c from the users and electronic devices.

The securement features 406 can be used to secure the securement straps 400a-400c to a slot in the housing of the electronic device to which a respective securement strap 400a-400c is secured. The conductive contacts 408 can be coupled to the antennas 402a-402c. The conductive contacts 408 can couple the antennas 402a-402c to conductive contacts in the slot of the electronic devices to which the respective securement strap 400a-400c is secured. The antennas 402a-402c can be coupled to a radio of the electronic device through the conductive contacts. The securement straps 400a-400c can be coupled to other securement straps through the end portion 410. The end portion 410 can include magnets, buckles, lugs (e.g., a pin-and-tuck closure), hook-and-loop fasteners, or any other suitable securement means. Holes, magnets, or other securement means can be included in securement straps to which the securement straps 400a-400c are secured, and can interface with the end portion 410. The end portion 410 can be weighted, or can include features to which a weight can be attached. This can aid in retaining the antennas 402a-402c in an extended position while a signal is broadcast through the antennas 402a-402c, maximizing antenna length. Thus, the antennas 402a-402c can be used to broadcast signals to lower frequencies, over greater ranges, and with improved efficiency.

In some examples, the end portion 410 and/or the antennas 402a-402c can include a conductive connector that can be used to couple the antennas 402a-402c to an antenna of a securement strap to which the securement straps 400a-400c are coupled. As an example, the end portion 410 can include a conductive lug that can be coupled to the antennas 402a-402c and can be coupled to an antenna of another securement strap through a conductive hole in the other securement strap. For electronic devices that include two securement straps, this can be used to increase a length and an effective radiating length of an antenna of the electronic device by coupling the antennas of both securement straps. Thus, the antennas 402a-402c can be used to broadcast signals to lower frequencies, over greater ranges, and with improved efficiency.

The antennas 402a-402c can be used to broadcast to low frequencies, such as frequencies in a range of about 80 MHz to about 500 MHz, in a range of about 120 MHz to about 450 MHz, in a range of about 100 MHz to about 250 MHz, in a range of about 100 MHz to about 175 MHz, about 100 MHz, about 120 MHz, about 150 MHz, about 160 MHz, about 240 MHz, about 400 MHZ, about 410 MHz, or other similar low frequencies. The antennas 402a-402c can be used to broadcast to a VHF frequency (in a range from about 30 MHz to about 300 MHz, or about 156.80 MHZ), an APRS frequency (about 144.390 MHZ), a VHF emergency frequency (about 146.520 MHZ), an international air distress frequency (in a range from about 110 MHz to about 250 MHz, about 121.50 MHz, or about 243.00 MHZ), a satellite search and rescue frequency (about 146.520 MHZ), a NWR SAME frequency (about 164 MHZ), or the like.

Any of the features, components, and/or parts, including the arrangements and configurations thereof shown in FIGS. 4A through 4C can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 4A through 4C.

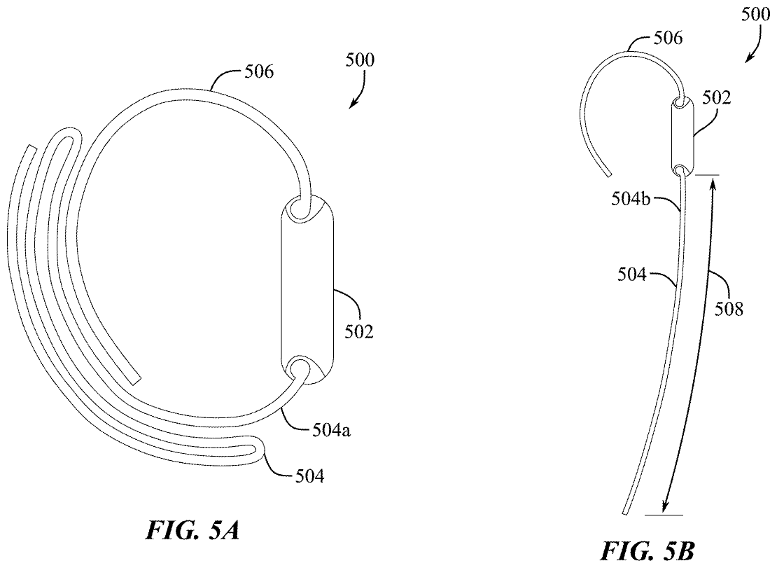

FIGS. 5A and 5B illustrate an electronic device 500 including a first securement strap 504 in a compact configuration 504a and an extended configuration 504b, respectively. The electronic device 500 can be the same as or similar to the electronic devices 100, 200, 302, discussed above with respect to FIGS. 1A through 3. The electronic device 500 can include a housing 502, a first securement strap 504 (illustrated in a compact configuration 504a and an extended configuration 504b), and a second securement strap 506. The first securement strap 504 can be coupled to the second securement strap 506 in order to secure the housing 502 to a user. The first securement strap 504 can be coupled to the second securement strap 506 by hook-and-loop fasteners, magnets, or the like. The first securement strap 504 can include an antenna, such as an antenna similar to or the same as any of the antennas 105, 206, 402a, 402b, 402c, discussed above with respect to FIGS. 1A through 4C. The antenna can extend through a length of the first securement strap 504 such that the antenna has a length substantially similar to a length 508 of the first securement strap 504. In some examples, the antenna can have a serpentine shape or the like, such that the antenna can have a length greater than a length of the first securement strap 504.

In FIG. 5A, the first securement strap 504 is in a compact configuration 504a. The first securement strap 504 can be in the compact configuration 504a by default, and a user can unfold or extend the first securement strap 504 to the extended configuration 504b when using an antenna included in the first securement strap 504. The first securement strap 504 can be retained in the compact configuration 504a through stitches, magnets, a material wrapped around the first securement strap 504, or the like. The first securement strap 504 can be retained in the compact configuration 504a by sacrificial features, such as stitches, that can be repaired or replaced after extending the first securement strap 504 to the extended configuration 504b in order to return the first securement strap 504 to the compact configuration 504a. The first securement strap 504 can be retained in the compact configuration 504a by reusable features, such as magnets, that can be used to return the first securement strap 504 to the compact configuration 504a without repair or replacement after the first securement strap 504 is extended to the extended configuration 504b. Retaining the first securement strap 504 in the compact configuration 504a prior to extending the first securement strap 504 to the extended configuration 504b reduces the size of the first securement strap 504, and can increase aesthetics of the electronic device 500 and improve user comfort.

Unfolding or extending the first securement strap 504 from the compact configuration 504a to the extended configuration 504b increases the effective radiating length of the antenna included in the first securement strap 504, which allows for the antenna to broadcast signals to lower frequencies, over greater ranges, and with improved efficiency. The first securement strap 504 can have a length of about 9 cm, about 10 cm, about 11 cm, about 12 cm, about 13 cm, about 14 cm, about 15 cm, about 16 cm, in a range from about 8 cm to about 17 cm, in a range from about 9 cm to about 15 cm, or the like in the compact configuration 504a. The first securement strap 504 can have a length 508 of about 40 cm, about 50 cm, about 60 cm, about 70 cm, about 75 cm, about 80 cm, about 90 cm, about 100 cm, greater than about 30 cm, greater than about 40 cm, greater than about 50 cm, greater than about 60 cm, greater than about 70 cm, in a range from about 40 cm to about 110 cm, in a range from about 65 cm to about 85 cm, or the like in the extended configuration 504b. The length 508 of the first securement strap 504 in the extended configuration 504b can be related to the frequency that the antenna of the electronic device 500 is configured to broadcast to. For example, the length 508 of the first securement strap 504 in the extended configuration 504b can be based on a wavelength, a half wavelength, or a quarter wavelength of a frequency to which the antenna of the electronic device 500 is configured to broadcast. In an example in which the electronic device 500 is configured to broadcast to a frequency of about 100 MHz having a wavelength of about 1.5 m, the first securement strap 504 can have a length 508 in the extended configuration 504b of about 75 cm (e.g., the length 508 of the antenna is half the wavelength of the frequency to which the antenna is configured to broadcast). The antenna can have a length equal to or greater than the length 508 of the first securement strap 504. Providing the electronic device 500 with the antenna having the length 508 configured to broadcast to a specific frequency can improve the efficiency of the electronic device 500 broadcasting to the selected frequency.

The antenna of the electronic device 500 can be used to broadcast to low frequencies, such as frequencies in a range of about 80 MHz to about 500 MHz, in a range of about 120 MHZ to about 450 MHz, in a range of about 100 MHz to about 250 MHz, in a range of about 100 MHZ to about 175 MHz, about 100 MHz, about 120 MHz, about 150 MHZ, about 160 MHz, about 240 MHz, about 400 MHz, about 410 MHz, or other similar low frequencies. The antenna can be used to broadcast to a VHF frequency (in a range from about 30 MHz to about 300 MHz, or about 156.80 MHZ), an APRS frequency (about 144.390 MHZ), a VHF emergency frequency (about 146.520 MHZ), an international air distress frequency (in a range from about 110 MHz to about 250 MHz, about 121.50 MHz, or about 243.00 MHZ), a satellite search and rescue frequency (about 146.520 MHZ), a NWR SAME frequency (about 164 MHZ), or the like.

The user can partially unfold or extend the first securement strap 504 from the compact configuration 504a towards the extended configuration 504b. For example, an effective radiating length of the antenna can be increased from the compact configuration 504a by an amount less than a maximum amount. This can be used to optimize radiation through the antenna to specific frequencies. For example, if a user of the electronic device 500 desires to send a signal over a specific frequency, the user can partially unfold or extend the first securement strap 504 based on the specific frequency. The user can unfold or extend the first securement strap 504 such that the antenna in the first securement strap 504 has an effective radiating length equal to a wavelength, a half wavelength, or a quarter wavelength of the frequency to which the antenna is desired to broadcast. Thus, the length of the antenna of the electronic device 500 can be adjustable, and this can be used to optimize radiation of a signal through the antenna to specific, desired frequencies. In some examples, the electronic device 500 can provide instructions (e.g., through a display, speakers, or the like of the electronic device 500) to a user for altering a length of the first securement strap 504 and an effective radiating length of the antenna based on a frequency to which the antenna of the first securement strap 504 is intended to broadcast.

Any of the features, components, and/or parts, including the arrangements and configurations thereof shown in FIGS. 5A and 5B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 5A and 5B.

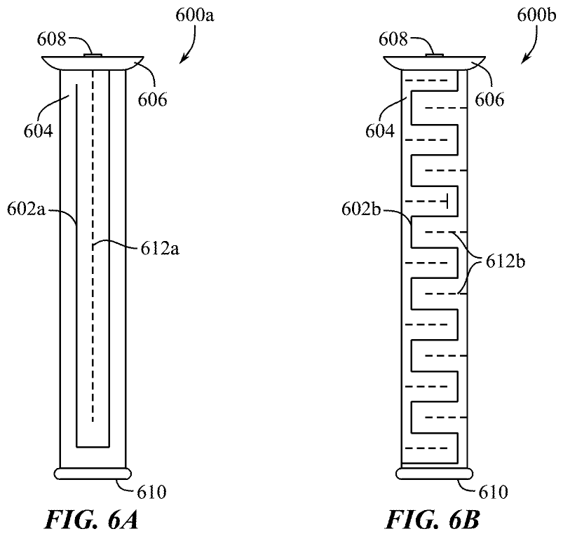

FIGS. 6A and 6B illustrate various configurations of antennas 602a, 602b in securement straps 600a, 600b. The securement straps 600a, 600b can be used in electronic devices, such as the electronic devices 100, 200, 302, discussed above with respect to FIGS. 1A through 3. The securement straps 600a, 600b can be the same as or similar to the securement straps 400a-400c discussed above with respect to FIGS. 4A through 4C, and can include components the same as or similar to the securement straps 400a-400c. As illustrated in FIGS. 6A and 6B, each of the securement straps 600a, 600b can include an antenna 602a, 602b, a band portion 604, a securement feature 606, a conductive contact 608, an end portion 610, and extension features 612a, 612b. Each of the antennas 602a, 602b can be embedded in or otherwise disposed in the respective securement straps 600a, 600b.

In the examples of FIGS. 6A and 6B, the extension features 612a, 612b can be provided in the band portions 604 of the securement straps 600a, 600b to straighten the antennas 602a, 602b, increasing effective radiating lengths of the antennas 602a, 602b. For example, a user of the securement straps 600a, 600b can rip, tear, or otherwise separate the band portions 604 along the extension features 612a, 612b in order to increase a linear length of the antennas 602a, 602b. This increases the effective length of the antennas 602a, 602b such that the antennas 602a, 602b can be used to broadcast signals to lower frequencies, over greater ranges, and with improved efficiency.

The user can partially separate the band portion 604 along the extension feature 612a, or can separate the band portion 604 along a number of the extension features 612b in order to selectively straighten the antennas 602a, 602b and increase the effective radiating length of the antennas 602a, 602b. For example, the effective radiating length of the antennas 602a, 602b can be increased by an amount less than a maximum amount. This can be used to optimize radiation through the antennas 602a, 602b to specific frequencies. For example, if a user of the securement straps 600a, 600b desires to send a signal over a specific frequency, the user can partially separate the band portion 604 along the extension feature 612a or can separate the band portion 604 along a number of the extension features 612b based on the specific frequency. Thus, the effective radiating length of the antennas 602a, 602b can be adjustable, and this can be used to optimize radiation of a signal through the antennas 602a, 602b to specific, desired frequencies.

Various types of features can be used for the extension features 612a, 612b. For example, the extension features 612a, 612b can include stitches, hook-and-loop fasteners, magnets, zippers, adhesives, or the like. The extension features 612a, 612b can include any features that are relatively weaker than a material of the band portion 604, which allows for the band portion 604 to be selectively separated along the extension features 612a, 612b. The extension features 612a, 612b can be sacrificial portions of the band portion 604, which cannot be repaired, such that the securement straps 600a, 600b are replaced after separating the extension features 612a, 612b. In some examples, the extension features 612a, 612b can be re-stitched or otherwise repaired after the band portion 604 is separated along the extension features 612a, 612b. The extension features 612a, 612b can be reusable portions of the band portion 604, such as hook-and-loop fasteners, magnets, or zippers, which can be returned to the configuration illustrated in FIGS. 6A and 6B (e.g., un-separated), without repair or replacement.

In an embodiment similar to the embodiment of FIG. 6B, the band portion 604 can include a textile material, such as a woven material. A user of the securement strap 600b can unravel the band portion 604, and see marks or other visual indicators that indicate an effective radiating length of the antenna 602b or a frequency to which the antenna 602b is optimized to broadcast at a respective effective radiating length. The visual indicators can include text, colors, or the like. In both of the examples illustrated in FIGS. 6A and 6B, the electronic device to which the securement straps 600a, 600b are coupled can provide instructions to a user for altering an effective radiating length of the antennas 602a, 602b based on a frequency to which the antennas 602a, 602b are intended to broadcast.

Separating the extension features 612a, 612b to straighten the antennas 602a, 602b increases the effective radiating lengths of the antennas 602a, 602b, which allows for the antennas 602a, 602b to broadcast signals to lower frequencies, over greater ranges, and with improved efficiency. Prior to separating the extension features 612a, 612b, the antennas 602a, 602b can have effective radiating lengths of about 9 cm, about 10 cm, about 11 cm, about 12 cm, about 13 cm, about 14 cm, about 15 cm, about 16 cm, in a range from about 8 cm to about 17 cm, in a range from about 9 cm to about 15 cm, or the like. After separating the extension features 612a, 612b, the antennas 602a, 602b can have effective radiating lengths of about 40 cm, about 50 cm, about 60 cm, about 70 cm, about 75 cm, about 80 cm, about 90 cm, about 100 cm, greater than about 30 cm, greater than about 40 cm, greater than about 50 cm, greater than about 60 cm, greater than about 70 cm, in a range from about 40 cm to about 110 cm, in a range from about 65 cm to about 85 cm, or the like. The effective radiating lengths of the antennas 602a, 602b in the extended configuration can be related to the frequencies that the antennas 602a, 602b are configured to broadcast to. For example, the effective radiating lengths of the antennas 602a, 602b in the extended configuration can be based on a wavelength, a half wavelength, or a quarter wavelength of a frequency to which the antennas 602a, 602b are configured to broadcast. In an example in which the securement straps 600a, 600b are configured to broadcast to a frequency of about 100 MHz having a wavelength of about 1.5 m, the antennas 602a, 602b can have effective radiating lengths in the extended configuration of about 75 cm (e.g., the effective radiating lengths of the antennas 602a, 602b are half the wavelength of the frequency to which the antennas 602a, 602b are configured to broadcast). Providing the securement straps 600a, 600b with antennas 602a, 602b having effective radiating lengths configured to broadcast to a specific frequency can improve the efficiency of the antennas 602a, 602b broadcasting to the selected frequency.

The antenna of the electronic device 500 can be used to broadcast to low frequencies, such as frequencies in a range of about 80 MHz to about 500 MHz, in a range of about 120 MHZ to about 450 MHz, in a range of about 100 MHz to about 250 MHz, in a range of about 100 MHZ to about 175 MHz, about 100 MHz, about 120 MHz, about 150 MHz, about 160 MHz, about 240 MHz, about 400 MHZ, about 410 MHz, or other similar low frequencies. The antenna can be used to broadcast to a VHF frequency (in a range from about 30 MHz to about 300 MHz, or about 156.80 MHZ), an APRS frequency (about 144.390 MHZ), a VHF emergency frequency (about 146.520 MHZ), an international air distress frequency (in a range from about 110 MHz to about 250 MHz, about 121.50 MHz, or about 243.00 MHZ), a satellite search and rescue frequency (about 146.520 MHZ), a NWR SAME frequency (about 164 MHZ), or the like.

Any of the features, components, and/or parts, including the arrangements and configurations thereof shown in FIGS. 6A and 6B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 6A and 6B.

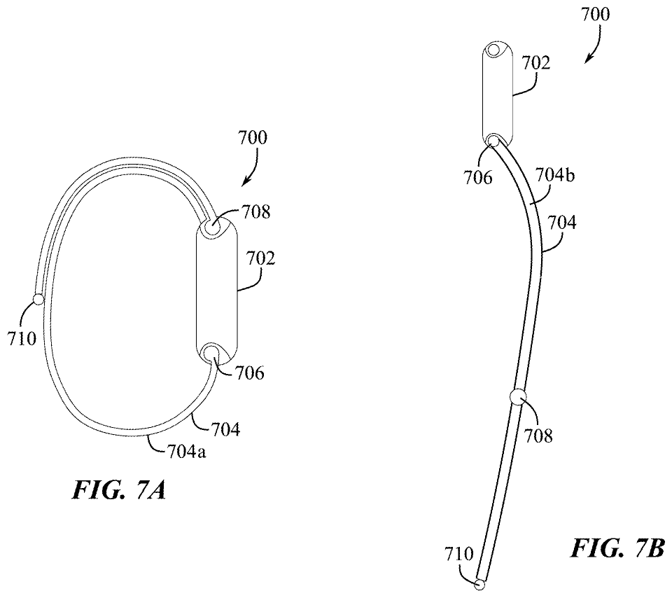

FIGS. 7A and 7B illustrate an electronic device 700 including a securement strap 704 in a compact configuration 704a and an extended configuration 704b, respectively. The electronic device 700 can be the same as or similar to the electronic devices 100, 200, 302, discussed above with respect to FIGS. 1A through 3. The electronic device 700 can include a housing 702, a securement strap 704 (illustrated in a compact configuration 704a and an extended configuration 704b), a first securement feature 706, a second securement feature 708, and an end portion 710. The first securement feature 706 and the second securement feature 708 can be coupled to the housing 702 and the end portion 710 can be coupled to the securement strap 704 to secure the housing 702 to a user. The securement strap 704 can include an antenna, such as an antenna similar to or the same as any of the antennas 105, 206, 402a, 402b, 402c, 602a, 602b, discussed above with respect to FIGS. 1A through 6B. The securement features 706, 708 can be the same as or similar to the securement features 406, 606, discussed above with respect to FIGS. 4A through 4C, 6A, and 6B. The end portion 710 can be the same as or similar to the end portions 410, 610, discussed above with respect to FIGS. 4A through 4C, 6A, and 6B.

In the example of FIGS. 7A and 7B, the electronic device 700 can include a single securement strap 704. The securement strap 704 can be coupled to the housing 702 at two locations, such as to opposite sides of the housing 702 through the first securement feature 706 and the second securement feature 708. The end portion 710 can be coupled to the securement strap 704, such as through magnets, hook-and-loop fasteners, or the like. The securement strap 704 can slide through the second securement feature 708, in order to adjust a linear length of the securement strap 704, and any slack in the securement strap 704 can be accommodated by the end portion 710 being coupled to the securement strap 704.

In FIG. 7A, the securement strap 704 is in a compact configuration 704a. The securement strap 704 can be in the compact configuration 704a when the electronic device 700 is worn by a user, and the user can unfold or extend the securement strap 704 to the extended configuration 704b when using an antenna included in the securement strap 704. The securement strap 704 can be retained in the compact configuration 704a through the securement features 706, 708 being secured in slots in the housing 702, and through magnets, hook-and-loop fasteners, or the like included in the securement strap 704 and the end portion 710. Retaining the securement strap 704 in the compact configuration 704a prior to extending the securement strap 704 to the extended configuration 704b reduces the size of the securement strap 704, improves aesthetics of the electronic device 700, improves user comfort, and aids in retaining the electronic device 700 on a user's body.

Unfolding or extending the securement strap 704 from the compact configuration 704a to the extended configuration 704b increases the effective radiating length of the antenna included in the securement strap 704, which allows for the antenna to broadcast signals to lower frequencies, over greater ranges, and with improved efficiency. The securement strap 704 can be extended by uncoupling the end portion 710 from the securement strap 704, and removing the second securement feature 708 from the slot in the housing 702. The housing 702 and the securement strap 704 can have a circumference in a range from about 12 cm to about 26 cm, in a range from about 14 cm to about 23 cm, in a range from about 17 cm to about 25 cm, or the like. The securement strap 704 can have a length of about 22 cm, about 23 cm, about 24 cm, about 26 cm, about 30 cm, or the like in the extended configuration 704b. In some examples, the securement strap 704 can include additional folds the same as or similar to the example of FIGS. 5A and 5B, or additional extension features the same as or similar to the example of FIGS. 6A and 6B in order to further increase the length of the securement strap 704 in the extended configuration 704b. The securement strap 704 can have a length of about 40 cm, about 50 cm, about 60 cm, about 70 cm, about 75 cm, about 80 cm, about 90 cm, about 100 cm, in a range from about 40 cm to about 110 cm, in a range from about 65 cm to about 85 cm, or the like in the extended configuration 704b.

The length of the securement strap 704 in the extended configuration 704b can be related to the frequency that the antenna of the electronic device 700 is configured to broadcast to. For example, the length of the securement strap 704 in the extended configuration 704b can be based on a wavelength, a half wavelength, or a quarter wavelength of a frequency to which the antenna of the electronic device 700 is configured to broadcast. In an example in which the electronic device 700 is configured to broadcast to a frequency of about 100 MHz having a wavelength of about 1.5 m, the securement strap 704 can have a length in the extended configuration 704b of about 75 cm (e.g., the length of the antenna is half the wavelength of the frequency to which the antenna is configured to broadcast). Providing the electronic device 700 with an antenna having a length configured to broadcast to a specific frequency can improve the efficiency of the electronic device 700 broadcasting to the selected frequency.

The antenna of the electronic device 700 can be used to broadcast to low frequencies, such as frequencies in a range of about 80 MHz to about 500 MHz, in a range of about 120 MHZ to about 450 MHz, in a range of about 100 MHz to about 250 MHz, in a range of about 100 MHZ to about 175 MHz, about 100 MHZ, about 120 MHz, about 150 MHZ, about 160 MHz, about 240 MHz, about 400 MHZ, about 410 MHz, or other similar low frequencies. The antenna can be used to broadcast to a VHF frequency (in a range from about 30 MHz to about 300 MHz, or about 156.80 MHZ), an APRS frequency (about 144.390 MHZ), a VHF emergency frequency (about 146.520 MHZ), an international air distress frequency (in a range from about 110 MHz to about 250 MHz, about 121.50 MHz, or about 243.00 MHZ), a satellite search and rescue frequency (about 146.520 MHZ), a NWR SAME frequency (about 164 MHZ), or the like.

The user can partially unfold or extend the securement strap 704 from the compact configuration 704a towards the extended configuration 704b. For example, the effective radiating length of the antenna can be increased by an amount less than a maximum amount. In some examples, the end portion 710 can be folded over and coupled to the securement strap 704 to increase the length of the securement strap 704 less than the amount illustrated by the extended configuration 704b. This can be used to optimize radiation through the antenna to specific frequencies. For example, if a user of the electronic device 700 desires to send a signal over a specific frequency, the user can partially unfold or extend the securement strap 704 based on the specific frequency. The user can unfold or extend the securement strap 704 such that the antenna in the securement strap 704 has an effective radiating length equal to a wavelength, a half wavelength, or a quarter wavelength of the frequency to which the antenna is desired to broadcast. Thus, the effective radiating length of the antenna of the electronic device 700 can be adjustable, and this can be used to optimize radiation of a signal through the antenna to specific, desired frequencies.

Any of the features, components, and/or parts, including the arrangements and configurations thereof shown in FIGS. 7A and 7B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 7A and 7B.

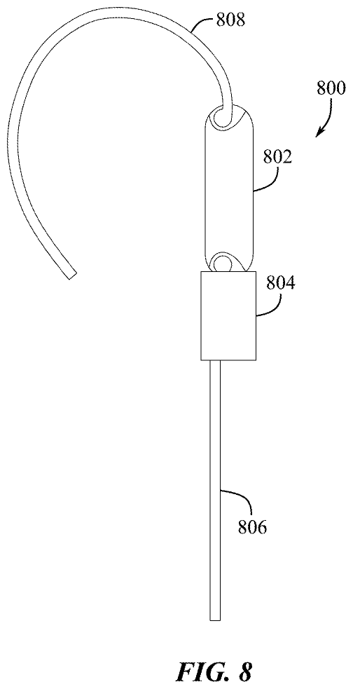

FIG. 8 illustrates an electronic device 800 including an antenna receptacle 804. The electronic device 800 can be the same as or similar to the electronic devices 100, 200, 302, discussed above with respect to FIGS. 1A through 3. The electronic device 800 can include a housing 802, an antenna receptacle 804, and a securement strap 808. The electronic device 800 can include a second securement strap secured in a slot of the housing 802 for normal use, and the second securement strap can be replaced in the slot by the antenna receptacle 804 in order to send signals over low frequencies, with increased range, and improved efficiency. The antenna receptacle 804 can house and dispense an antenna 806, which may be similar to or the same as any of the antennas 105, 206, 402a, 402b, 402c, 602a, 602b, discussed above with respect to FIGS. 1A through 7B. The antenna receptacle 804 can include a conductive contact, which can be the same as or similar to the conductive contacts 240, 408, 608, discussed above with respect to FIGS. 2A through 2E, 4A through 4C, 6A, and 6B, for coupling the antenna 806 to a radio of the electronic device 800.

The antenna receptacle 804 can house and dispense the antenna 806 with an increased length in a small, portable package. The antenna 806 or the antenna receptacle 804 can include linear measurement markings to indicate an effective radiating length of the antenna 806 to a user as the antenna 806 is dispensed or extended from the antenna receptacle 804. The linear measurement markings can indicate the effective radiating length of the antenna 806, and/or frequencies to which the antenna 806 can optimally radiate at different respective effective radiating lengths. The antenna receptacle 804 can include a spool around which the antenna 806 is wrapped, and the antenna 806 can be spooled from or to the spool as the antenna 806 is dispensed from or retracted into the antenna receptacle 804. The antenna 806 can include a stiff material such that the antenna 806 extends from the antenna receptacle 804 stiff and straight, maximizing the effective radiating length of the antenna 806. The antenna 806 can retract into a coil. The antenna receptacle 804 can include a spring or crank in order to spool the antenna 806 into the antenna receptacle 804 and retract the antenna 806 into the antenna receptacle. The antenna receptacle 804 can be a replacement part for the electronic device 800, such that the electronic device operates normally without the antenna receptacle 804, and operates to send signals to lower frequencies with increased range and efficiency when the antenna receptacle 804 is coupled to the housing 802. In some examples, the antenna 806 can telescope or otherwise be dispensed from the antenna receptacle 804.

Dispensing the antenna 806 from the antenna receptacle 804 increases the effective radiating length of the antenna 806, which allows for the antenna 806 to broadcast signals to lower frequencies, over greater ranges, and with improved efficiency. The antenna 806 can be dispensed by pulling an end of the antenna 806 away from the antenna receptacle 804. The antenna 806 can have an effective radiating length of about 40 cm, about 50 cm, about 60 cm, about 70 cm, about 75 cm, about 80 cm, about 90 cm, about 100 cm, in a range from about 40 cm to about 110 cm, in a range from about 65 cm to about 85 cm, or the like.

The length of the antenna 806 that is dispensed from the antenna receptacle 804 can be related to the frequency that the antenna 806 is configured to broadcast to. For example, the length of the antenna 806 that is dispensed can be based on a wavelength, a half wavelength, or a quarter wavelength of a frequency to which the antenna 806 is configured to broadcast. In an example in which the electronic device 800 is configured to broadcast to a frequency of about 100 MHz having a wavelength of about 1.5 m, the antenna 806 can be dispensed to a length of about 75 cm (e.g., the length of the antenna 806 is half the wavelength of the frequency to which the antenna 806 is configured to broadcast). Providing the electronic device 800 with the antenna receptacle 804 and the antenna 806 that can be adjustably dispensed (e.g., with an adjustable effective radiating length) configured to broadcast to a specific frequency can improve the efficiency of the electronic device 800 broadcasting to the selected frequency. In some examples, the electronic device 800 can provide instructions (e.g., through a display, speakers, or the like of the electronic device 800) to a user for altering a length of the antenna 806 that is dispensed from the antenna receptacle 804 based on a frequency to which the antenna 806 is intended to broadcast.

The antenna 806 of the electronic device 800 can be used to broadcast to low frequencies, such as frequencies in a range of about 80 MHz to about 500 MHz, in a range of about 120 MHz to about 450 MHz, in a range of about 100 MHz to about 250 MHz, in a range of about 100 MHz to about 175 MHz, about 100 MHZ, about 120 MHz, about 150 MHz, about 160 MHz, about 240 MHz, about 400 MHz, about 410 MHz, or other similar low frequencies. The antenna 806 can be used to broadcast to a VHF frequency (in a range from about 30 MHz to about 300 MHz, or about 156.80 MHZ), an APRS frequency (about 144.390 MHZ), a VHF emergency frequency (about 146.520 MHZ), an international air distress frequency (in a range from about 110 MHz to about 250 MHz, about 121.50 MHz, or about 243.00 MHz), a satellite search and rescue frequency (about 146.520 MHZ), a NWR SAME frequency (about 164 MHZ), or the like.

Any of the features, components, and/or parts, including the arrangements and configurations thereof shown in FIG. 8 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 8.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. An electronic device comprising:
a device housing defining an internal volume;
a radio disposed in the internal volume;
an antenna disposed outside the internal volume and coupled to the radio through the device housing; and
a conductive element coupled to a ground of the radio, the conductive element extending from the internal volume through the device housing to an exterior of the device housing, the conductive element defining at least a portion of an exterior surface of the electronic device.

2. The electronic device of claim 1, further comprising a securement strap coupled to the device housing, wherein:
the antenna is embedded in the securement strap; and
the securement strap comprises a conductive contact coupling the antenna to the radio.

3. The electronic device of claim 2, wherein:
the conductive contact comprises a first conductive contact;
the securement strap is received in a slot in the device housing; and
the slot comprises a second conductive contact coupling the first conductive contact to the radio.

4. The electronic device of claim 1, further comprising:
a first securement strap, wherein the antenna is a first antenna disposed in the first securement strap; and
a second securement strap comprising a second antenna disposed therein, wherein the second antenna is coupled to the first antenna.

5. The electronic device of claim 1, wherein the conductive element extends around a circumference of the device housing.

6. A securement strap for an electronic device, the securement strap comprising:
a band;
an antenna in the band; and
a contact in the band and coupled to the antenna, the contact configured to couple the antenna to an electronic device, wherein:
an effective radiating length of the antenna is adjustable to improve radiation of a signal through the antenna to a specific frequency.

7. The securement strap of claim 6, wherein:
the band has a first configuration and a second configuration;
the first configuration comprises a folded compact configuration; and
the second configuration comprises an unfolded deployed configuration.

8. The securement strap of claim 7, wherein:
the band comprises a securement feature configured to retain the band in the compact configuration; and
the securement feature comprises at least one of a stitch, a magnet, a wrap at least partially encircling the band, or a hook-and-loop fastener.

9. The securement strap of claim 6, wherein:
the band comprises an extension feature extending parallel to the antenna; and
the band is configured to separate along the extension feature to adjust the effective radiating length of the antenna.

10. The securement strap of claim 6, wherein:
the band comprises an extension feature extending perpendicular to the antenna; and
the band is configured to separate along the extension feature to adjust the effective radiating length of the antenna.

11. The securement strap of claim 6, wherein:
the antenna has a rectangular serpentine shape;
the band comprises a plurality of extension features; and
the band is configured to separate along the extension features to adjust the effective radiating length of the antenna.

12. The securement strap of claim 6, wherein the contact comprises a spring pin.

13. The securement strap of claim 6, wherein the contact comprises an inductive contact.

14. The securement strap of claim 6, wherein the band has a length of at least 40 cm.

15. The securement strap of claim 6, wherein the antenna comprises at least one of an S-shaped serpentine pattern or a conductive grid.

16. An electronic device comprising:
a device housing;
a radio in the device housing;
an antenna connector coupled to the radio, the antenna connector configured to couple an antenna to the radio through the device housing; and
a conductive element coupled to the radio, the conductive element defining an exterior surface of the device housing.

17. The electronic device of claim 16, further comprising an antenna receptacle coupled to the antenna connector, the antenna receptacle comprising a retractable antenna coupled to the radio through the antenna connector.

18. The electronic device of claim 16, wherein the antenna connector comprises a conductive contact or an inductive coil coupled to the radio.

19. The electronic device of claim 16, further comprising:
a first slot in the device housing, wherein the antenna connector is disposed in the first slot;
a second slot in the device housing;
a securement strap comprising a first securement feature received in the first slot and a second securement feature received in the second slot; and
an antenna coupled to the antenna connector, wherein an effective radiating length of the antenna is configured to be increased by removing the second securement feature from the second slot.

20. The electronic device of claim 16, further comprising:
a slot in the device housing, wherein the antenna connector is disposed in the slot; and
a securement strap comprising:
an antenna coupled to the antenna connector; and
a securement feature received in the slot, wherein lengths of the securement strap and the antenna are adjustable by unfolding the securement strap.
